(19) United States
(12) Patent Application Publication
(10) Pub. No.: US 2016/0190624 A1
(43) Pub. Date: Jun. 30, 2016

(54) FLOW TYPE ZINC AIR FUEL CELL

(71) Applicant: Wen Huang LIAO, Taipei City (TW)

(72) Inventor: Wen Huang LIAO, Taipei City (TW)

(21) Appl. No.: 14/584,614

(22) Filed: Dec. 29, 2014

(51) Int. Cl. H01M 8/06; H01M 10/46; H01M 12/08; H01M 4/134; H01M 8/04

(52) U.S. Cl. CPC H01M 8/0656; H01M 4/134; H01M 8/04201; H01M 12/08; H01M 10/46

(57) ABSTRACT

The present invention provides a flow type zinc air fuel cell. The flow type zinc air fuel cell is a closed pipeline. The closed pipeline includes a discharging pipeline and a charging pipeline that is in connection with the discharging pipeline. In addition, the charging pipeline includes a flow type zinc electrode that is in a slurry state. The outer periphery of the zinc electrode is encapsulated by a metal electricity collecting pipe. Subsequently, the outer periphery of the metal collecting electricity pipe is encapsulated by an insulating film. Then, the outer periphery of the insulating film is encapsulated by an air electrode. After that, the outer periphery of the air electrode is encapsulated by a housing comprising a plurality of through holes that enable air to enter the air electrode. At least one driving device exists in between the discharging pipeline and the charging pipeline. Subsequent to an oxidation of the zinc electrode in the discharging pipeline, the zinc electrode is driven to the charging pipeline by the driving device. In addition, the zinc electrode is gradually reduced in the charging pipeline, and the zinc electrode is pushed to the discharging pipeline by the driving device, to form a continuous cyclical oxidation and reduction reaction that generates electricity.

### FIELD OF THE INVENTION

The present invention relates generally to a fuel cell having an oxidation reduction reaction with air by means of a zinc material, and more particularly, the present invention relates to a zinc air fuel cell that enables a negative electrode (an anode) which comprises zinc material to be designed for carrying out reaction with air in a slurry state, and also enabling the fuel cell to continuously carry out an oxidation reduction reaction without having to supplement or replace the negative electrode (an anode) material or without having to remove any waste.

### BACKGROUND OF THE INVENTION

Energy is the driving force of economic development, and it is also a measure of overall national strength. In addition, energy is an important indicator of the degree of development of the national culture, the living standards of people and the social progress of history. This shows that every breakthrough in energy technology innovation and development of the productive forces of society bring about a significant and far-reaching change. Energy technology has proved to be very important and also has an important influence for the future an emerging industry.

For the twenty-first century, the protection of environment and the sustainable development of human society have become an immediate concern of the premise of public issues for the world, and may also be the core of sustainable development strategy. In addition, they may also be the key factors to affect decisions on the current world energy as well as technology-oriented decisions; they may also be a tremendous impetus to promote the development of energy technology. A huge energy system built up in the 20^{th} century has been unable to adapt to the future society for the requirements of the efficient, clean, economical and safe energy systems. As such, energy development is facing a huge challenge.

Following the development of polymer cells and the development of new technologies, the different types of polymer cells have been increased. At the same time, due to the increased use of 3C products, cells that are even thinner, lighter and smaller are sold in the mainstream market. The cells that have a solid state polymer as their solid electrolyte have a lot of benefits in terms of their safety, workability and they may be used at high temperatures. The benefits exist because the user does not need to worry about the function of the cell being reduced or affected due to a reduction of the electrolyte in the insulating film, as a result of the packaging of the electrolyte being incomplete, or as a result of the cell having been placed for a long time. Moreover, if used at high temperatures, the cell may have better function, and this is the reason why a solid state polymer cell would be a major breakthrough in the development of cells.

Cells may be classified into two main types, which are chemical cells and physical cells. In particular, chemical cells can be further classified into three types such as primary cell, secondary cell and fuel cell. A fuel cell is also known as a continuous cell, whereby the main characteristics of a fuel cell may be that a fuel cell has a positive electrode as well as a negative electrode, and active substances may not be present in the fuel cell. In addition, another characteristic of the fuel cell is that active materials need to be supplied externally and continuously to the fuel cell, so as to enable the fuel cell to be discharged continuously. The positive electrode (cathode) of the fuel cell is oxidized by a reaction with air or oxygen. Accordingly, fuel cells may also be known to be a highly efficient source of green energy, since these cells may be environmentally friendly and may also be non-toxic.

The development of human civilization occurred until the late 1970s. The highly efficient zinc air fuel cells may be produced on a large scale, and may be widely used in low power electronic products, for example, in hearing aids and calculators. From the 1980s till today, large-scale zinc air fuel cells gradually become major applications in cars, and by the 1990s, large-scale zinc air fuel cells are being used in electric vehicles.

However, among all of the types of fuel cells, in the present day, the zinc air fuel cell may provide the highest energy density on the basis of all of the electrolyte-based cells. Besides being reliable and safe, the other advantages of zinc air fuel cells include having low costs of manufacture, being easily recycled, and having low pollution rate. Usually, the zinc air fuel cell uses potassium hydroxide as its electrolyte. In order to increase the solubility of zinc oxide in the electrolyte, and to prevent the phenomenon of polarization of the fuel cell, the molarity of the potassium hydroxide of the zinc air fuel cell may be as high as 8 molar (M).

Traditionally, whole pieces of old-fashioned zinc blocks were used as the negative electrode (anode) of the zinc air fuel cell, and continued development of the negative electrode has led to the zinc plate-shaped electrode 1 as well as the zinc particle-shaped electrode 2 that are commonly used nowadays. These may be non-rechargeable primary cells. As shown in FIG. 1, the zinc plate-shaped electrode represents the zinc metal being made into a plate-shaped structure 11. The zinc plate-shaped electrode mainly includes a zinc anode plate 12 having the plate-shaped 11, and a cathode plate 13, whereby the zinc anode plate 12 performs the function of the negative electrode (anode), and at the same time performing the function of the fuel of the zinc air fuel cell. The zinc air fuel cell acts as a depolarizing agent by using the hydrogen atoms of oxygen from the air 14. The air 14 enters the structure of the zinc air fuel cell by means of diffusion, via the side of the cathode plate 13. The zinc anode plate 12 is generally placed in the container of the cell that is filled with electrolyte. Regeneration of this type of cell may be achieved by replacing a cassette-type zinc electrode with electrolyte. Protrusions of the zinc anode plate 12 and the cathode plate 13 may be extended for connecting the wires, respectively.

Besides being made up of a dense zinc metal plate, the zinc plate-shaped electrode 1 may also be made up of a zinc metal plate having a plurality of pores (not shown in the drawings). The methods of manufacturing the zinc metal plate having a plurality of pores may include sintering, coating, mixing with a polymer binder, adhering or plating and so on. The method of manufacturing the zinc metal plate is completed by fixing the zinc particles on a mesh of inert metal substrate. The size and distribution of the pores of the anode that constitutes the zinc metal plate having a plurality of pores will affect the function of the anode and loss of capacitance of the anode.

Relatively speaking, as shown in FIG. 2, the zinc particle-shaped electrode 2 is used as a unit of the zinc air fuel cell. The electrode that is filled with zinc particles 21 or zinc powder (not shown in the drawings) may be an anode to perform the function of fuel. The working theory of this is similar to the working theory of the zinc anode plate 12. Similarly, the air 14 enters the structure of the zinc air fuel cell by means of diffusion, via the side of the cathode plate 13. Subsequent to completion of reaction of the zinc particles 21 or the zinc powder, the unit of the cell may continue to supply the power needed as long as the electrode is filled appropriately.

Zinc particle-shaped electrode 2 of the zinc air fuel cell is normally used in small button cell, and is used particularly in the cell pack of the electronic hearing aids. Such hearing aids include hearing aids which are programmable. Such a small cell generally has a plate having a cylindrical shape.

However, the use of a conventional zinc particle-type electrode 2 directly enables the plurality of zinc metal particles to disperse in an electrolyte 22 (electrolyte), together with a current collector as an electrode, a zinc air fuel cell may be formed. In order to avoid the plurality of zinc metal particles settling to the bottom of the electrolyte 22, and the stability of the discharging may be affected, a gel additive formed by the electrolyte 22 may be added to the zinc air fuel cell, such as: carboxymethyl cellulose, in order to enable the plurality of zinc metal particles may be uniformly dispersed in the electrolyte 22.

In summary, the drawbacks of the aforementioned prior art may be provided as follows: (I) after completion of reaction of the zinc air fuel cell, the fuel, after complete oxidation of the fuel, must be replaced or supplemented, and waste may be produced to pollute the environment, such that the fuel must be additionally refilled or replaced; and (II) the anode electrode fuel is a solid or semi-solid type, such that the area in contact with the air reaction is limited.

### SUMMARY OF THE INVENTION

The main objective of the present invention is to design the zinc electrode of the zinc air fuel cell as a flow type electrode, so as to enable free circulation of the zinc electrode in between the discharging pipeline as well as the charging pipeline of the closed pipeline. Moreover, the design of the zinc electrode of the present invention also enables continuous reactions involving the transfer of chemical energy to electrical energy to be carried out, such as oxidizing discharging reactions and reduction charging reactions. As such, the material that is within the zinc air fuel cell does not need to be supplemented or replaced, and excess waste will not be produced. With zero pollution, the use of the zinc air fuel cell is both economical and environmentally friendly.

The other objective of the present invention is to have a tubular design of the zinc air fuel cell, together with the use of a flow type zinc electrode. When the zinc electrode is driven and operated by the driving device, and when a change in the flow of the zinc electrode is produced, the non-reacted zinc electrode significantly increases the total surface area of contact with oxygen, and as such increasing the discharging efficiency of the zinc air fuel cell.

An additional objective of the present invention is that the driving device and the charging pipeline may be respectively designed as a positive and a negative electrode for carrying out reduction reaction of the zinc electrode that has been oxidized, so as to simplify the design of pipelines of the zinc air fuel cell.

In order to achieve the aforesaid objective, the flow type zinc air fuel cell of the present invention may include a closed pipeline, whereby the closed pipeline has a discharging pipeline and a charging pipeline which is in connection with the discharging pipeline. Furthermore, the charging pipeline includes a flow type zinc electrode that may be in a slurry state, and at least one driving device may exist in between the discharging pipeline and the charging pipeline. The flow of the zinc electrode in the discharging pipeline and the charging pipeline may be driven continuously by the driving device. In addition, the discharging pipeline may further include a pressure device that may increase the speed of the displacement and flow of the zinc electrode.

In accordance with a preferred exemplary embodiment of the present invention, the zinc electrode may be made up of a compound or a mixture that contains zinc metals; and the zinc metals may include one of zinc particles or zinc powders, or a mixture thereof.

Moreover, the driving device may include a driving source and a screw that moves back and forth and that is also being driven by the driving source in a single direction.

Subsequent to the zinc electrode being oxidized in the discharging pipeline, the zinc electrode may be pushed by the driving device to the charging pipeline. In the charging pipeline, the zinc electrode may be reduced gradually, and the zinc electrode may be pushed by the driving device to the discharging pipeline, so as to form a continuous cyclical oxidation and reduction reaction which generates electricity.

In accordance with an preferred exemplary embodiment of the present invention, the outer periphery of the zinc electrode may be encapsulated by a metal electricity collecting pipe, and the material of the metal electricity collecting pipe may comprise one of copper or nickel. The outer periphery of the metal collecting electricity pipe may be encapsulated by an insulating film; the outer periphery of the insulating film may be encapsulated by an air electrode; the outer periphery of the air electrode may be encapsulated by a housing that has a plurality of through holes that enable air to enter the air electrode. The benefits of the aforesaid design of one layer being completely encapsulated by another layer, in combination with the design of the pipeline of the present invention, may be to enable the external air or oxygen to enter the zinc electrode located within the (discharging pipeline and charging pipeline) from all angles from the outside. In addition, due to the fact that the zinc electrode of the present invention includes a flow type material, and since the zinc electrode may be able to flow and may have the chance to be in contact with the external air or oxygen of the positive electrode (cathode) as a result of the driving device and the pressure device, the contact surface area for carrying out reduction reaction between the negative electrode (anode) and the positive electrode (cathode) can thus be significantly increased.

In addition, in one preferred exemplary embodiment of the present invention, the charging pipeline includes a metal mesh which is in connection with the housing; the screw and the metal mesh make up a group of positive and negative electrodes that may carry out the reduction reaction of the zinc electrode within the charging pipeline subsequent to oxidation.

Relatively speaking, in another preferred exemplary embodiment of the present invention, the charging pipeline may include a metal pipeline which is in connection with the housing; and the metal pipeline further includes a hollow metal rod piece. The metal pipeline and the metal rod piece perform the function of a group of positive and negative electrodes that may carry out the reduction reaction of the zinc electrode within the charging pipeline subsequent to oxidation; whereby the surface of the metal rod piece has a plurality of air holes, and the oxygen produced subsequent to a reduction reaction of the oxidized zinc electrode enters the metal rod piece, and may be guided released through the metal rod piece.

It is clear from the above that the special distinguishing technical features of the present invention may be as follows: subsequent to the zinc electrode (negative electrode) being oxidized when flowing past the discharging pipeline, and subsequent to the generation of electricity, the zinc electrode may be pushed by the driving device to the charging pipeline from the discharging pipeline. While flowing in the charging pipeline, the zinc electrode may be reduced gradually and thus generating electricity. This is followed by the driving device pushing the zinc electrode that has been reduced to the discharging pipeline. The flow of the zinc electrode along the above-mentioned route may enable a continuous cyclical oxidation and reduction reaction to be achieved, leading to the generation of electricity. As such, the material of the negative electrode that is within the zinc air fuel cell of the present invention does not need to be supplemented or manually replaced, and excess waste that may be damaging to the environment will not be produced. The use of the zinc air fuel cell of the present invention is economical, environmentally friendly and also has the benefit of having an increased lifespan of the fuel cell.

### BRIEF DESCRIPTION OF THE DRAWINGS

The present invention can be understood in more detail by reading the subsequent detailed description in conjunction with the examples and preferred exemplary embodiments made to the accompanying drawings, wherein:

FIG. 1 is a three-dimensional schematic diagram of a conventional zinc air cell having a plate-shaped zinc electrode.

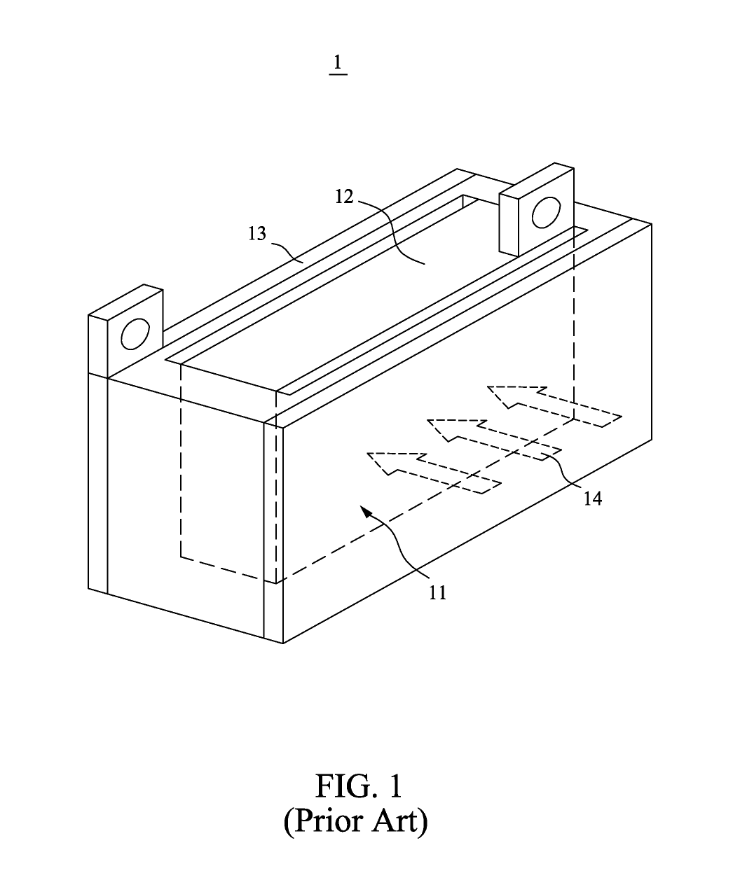

FIG. 2 is a cross-sectional schematic diagram illustrating a conventional zinc air cell having zinc particles.

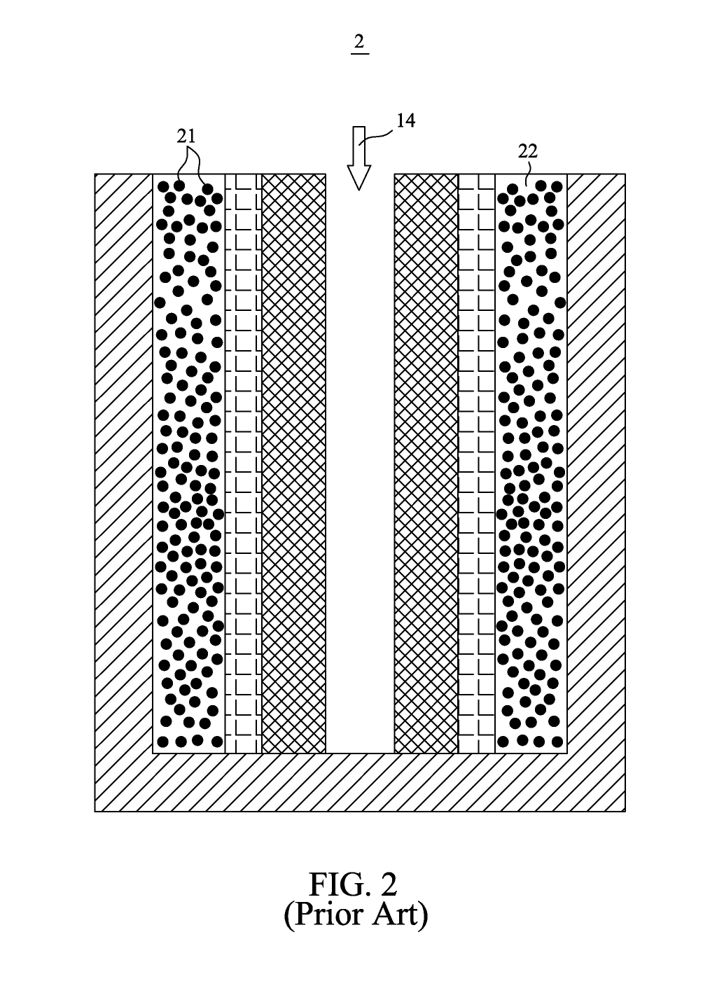

FIG. 3 is a schematic diagram illustrating a structure of a flow-type zinc air fuel cell in accordance with a preferred exemplary embodiment of the present invention.

FIG. 4 is a three-dimensional schematic diagram illustrating a partial charging pipeline segment in accordance with the preferred exemplary embodiment of the present invention.

FIG. 5 is a cross-sectional schematic diagram illustrating the partial charging pipeline segment as shown in FIG. 4 in accordance with the preferred exemplary embodiment of the present invention.

FIG. 6 is a schematic diagram illustrating a driving device together with the partial charging pipeline segment performing a reduction reaction in accordance with the preferred exemplary embodiment of the present invention.

FIG. 7 is a schematic diagram illustrating the partial charging pipeline segment alone performing a reduction reaction in accordance with the preferred exemplary embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate the preferred exemplary embodiments of the invention and, together with the description, serve to explain the principles of the invention.

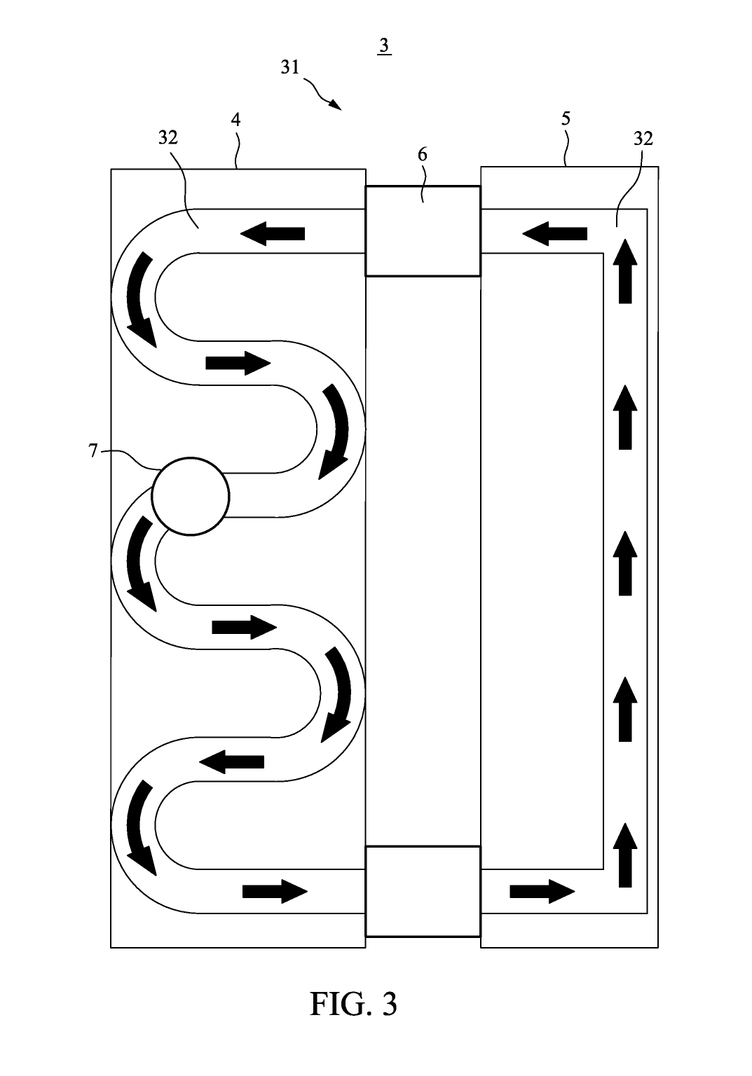

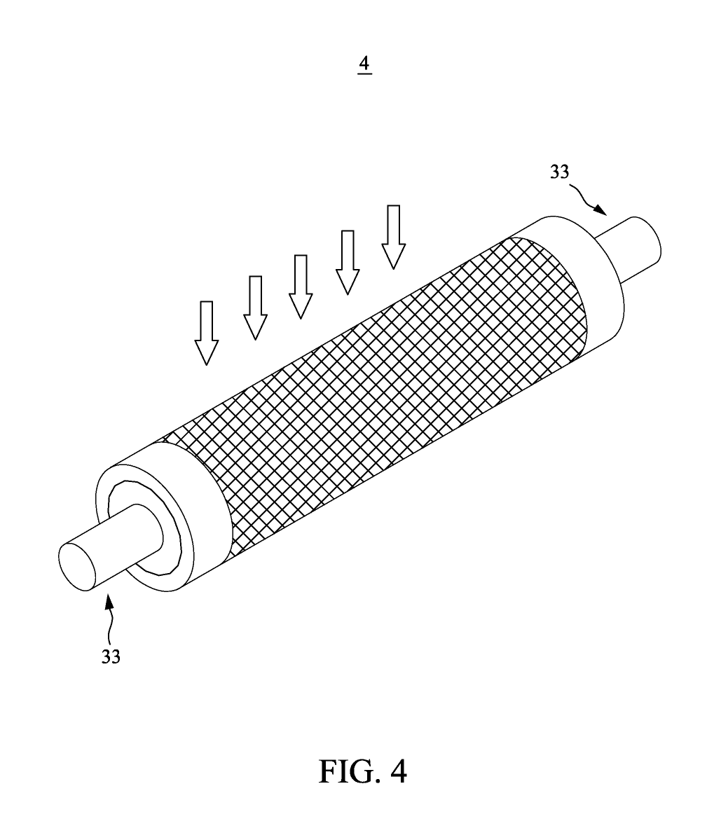

Referring to FIG. 3 and FIG. 4, in accordance with a preferred exemplary embodiment of the present invention, the flow type zinc air fuel cell 3 of the present invention may include a closed pipeline 31. The air or oxygen from the outside (as shown by the arrows in the drawings) may enter the interior of the flow type zinc air fuel cell via the various arc shaped angles. The flow type zinc air fuel cell may be mainly made up of three parts: a discharging pipeline 4, a charging pipeline 5 and at least one driving device 6. The charging pipeline 5 may be in connection with the two opposite ends of the discharging pipeline 4. In accordance with a preferred exemplary embodiment of the present invention, two driving devices 6 may be respectively assembled in between the discharging pipeline 4 and the charging pipeline 5.

In accordance with a preferred exemplary embodiment of the present invention, due to the fact that the negative electrode (anode) of the zinc air fuel cell 3 of the present invention may be a flow type zinc electrode 32 that is also in a slurry state, the zinc electrode 32 may be pushed from the discharging pipeline 4 to the charging pipeline 5 by the driving device 6, when the zinc electrode 32 flows to the end of the charging device 5, the zinc electrode 32 may be further pushed by the driving device 6 from the charging pipeline 5 to the discharging pipeline 4, in order for the zinc electrode 32 to be displaced.

Furthermore, in order to ensure the mobility as well as the speed and displacement efficiency of the zinc electrode 32 in the discharging pipeline 4, a pressure device 7 may be further assembled on the discharging pipeline 4 of the present invention. In accordance with a preferred exemplary embodiment of the present invention, the pressure device 7 may be set as a device that releases air bubbles, or may be set as a pressurized pump type device. The addition of air bubbles to the zinc electrode 32 may increase the mobility and uniformity of the zinc electrode 32 within the discharging pipeline 4; or the mobility of the zinc electrode 32 within the discharging pipeline 4 may also be ensured by the pressurize pump type device exerting a pressure on the zinc electrode 32 when the zinc electrode 32 passes through the pressurized pump type device.

In accordance with a preferred exemplary embodiment of the present invention, the zinc electrode 32 may be made up of a compound or a mixture containing zinc metals, and the zinc metals may include one of zinc particles or zinc powder, or a mixture thereof.

Moreover, in accordance with a preferred exemplary embodiment of the present invention, as shown in FIG. 4, in order to ensure that the power generated by the zinc electrode 32 in the discharging pipeline 4 is completely maintained and is not dissipated during the procedure of discharging, the two ends of the discharging pipeline 4 may be extended, and an electricity collecting pipe 33 may be formed respectively on both the left end and the right end that collects all of the electricity generated in the present invention.

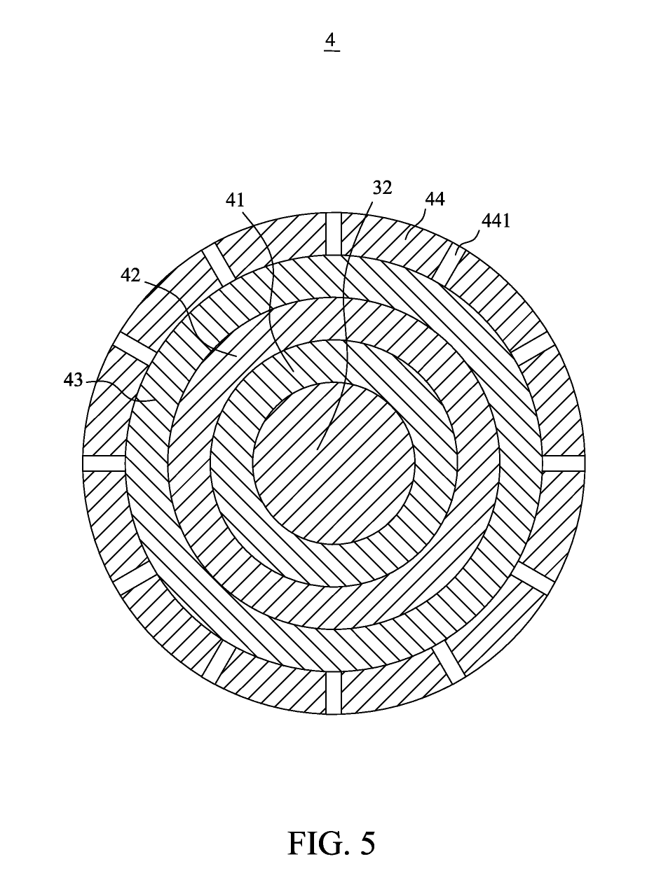

In addition, as shown in FIG. 5, in accordance with a preferred exemplary embodiment of the present invention, the structure of the discharging pipeline 4 may be made up of following: the outer periphery of the zinc electrode 32 may be completely encapsulated by a metal electricity collecting pipe 41; the outer periphery of the metal collecting electricity pipe 41 may be completely encapsulated by an insulating film 42; the outer periphery of the insulating film 42 may be completely encapsulated by an air electrode 43; the outer periphery of the air electrode 43 may be completely encapsulated by a housing 44; and the housing 441 may include a plurality of through holes 441 that enable air from the outside or oxygen to enter the air electrode 43. In accordance with a preferred exemplary embodiment of the present invention, the material of the metal electricity collecting pipe 41 may be made up of one of copper or nickel.

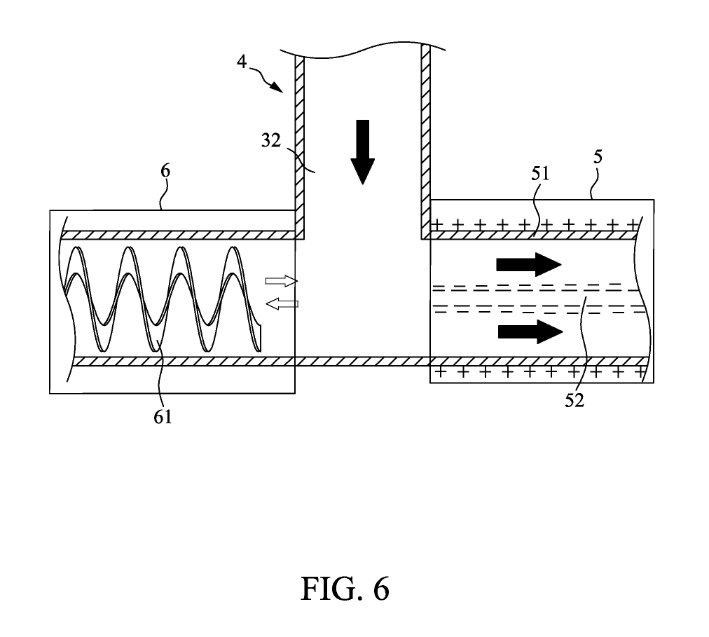

As shown in FIG. 6, in accordance with a preferred exemplary embodiment of the present invention, the charging pipeline 5 may have a metal pipeline 51 that is in connection with the housing 44; and the metal pipeline 51 may further include a hollow metal rod piece 52. The driving device 6 may have a driving source and a screw 61 that move back and forth and that is also being driven by the driving source in a single direction. In addition, in accordance with a preferred exemplary embodiment of the present invention, the screw 61 may be made up of plastic material. The metal pipeline 51 and the metal rod piece 52 may perform the function of a group of positive and negative electrodes that have opposite electrical properties. The metal pipeline 51 of the charging pipeline 5 may be the positive electrode (cathode), and relative to this, the metal rod piece 52 of the charging pipeline 5 may be the negative electrode (anode).

In accordance with a preferred exemplary embodiment of the present invention, when the zinc electrode 32 flows past the discharging pipeline 4, it may become oxidized zinc electrode 32 through a reaction with air or oxygen. The oxidized zinc electrode 32 may be gradually reduced by both the metal pipeline 51 and the metal rod piece 52 when the oxidized zinc flows past the charging pipeline 5. Finally, after leaving the charging pipeline 5, the zinc electrode 32 may enter the discharging pipeline 4 and enabling the process of converting chemical energy into electrical energy to be started once again by a reaction with air or oxygen. The closed pipeline 31 of the present invention may enable a continuous flow and displacement of the zinc electrode 32, while at the same time enabling oxidation and reduction reaction of the zinc electrode 32 to be performed. As such the zinc electrode 32 material that is within the zinc air fuel cell does not need to be supplemented or replaced, and electricity may be generated on a continuous basis for long periods of time. Moreover, the generation of electricity by this manner may also comply with having a source of green energy and zero pollution, as well as being environmentally friendly.

Furthermore, in accordance with a preferred exemplary embodiment of the present invention, during the process of reducing the zinc electrode 32, due to the fact that the surface of the metal rod piece 52 has a plurality of air holes, and that the structure of the metal rod piece 52 has a hollow design at the same time, the oxygen which is produced subsequent to reduction reaction of the oxidized zinc electrode 32 enters the air holes of the metal rod piece 52, and the oxygen may be released in a guided manner via the hollow metal rod piece 52, at the charging pipeline 5.

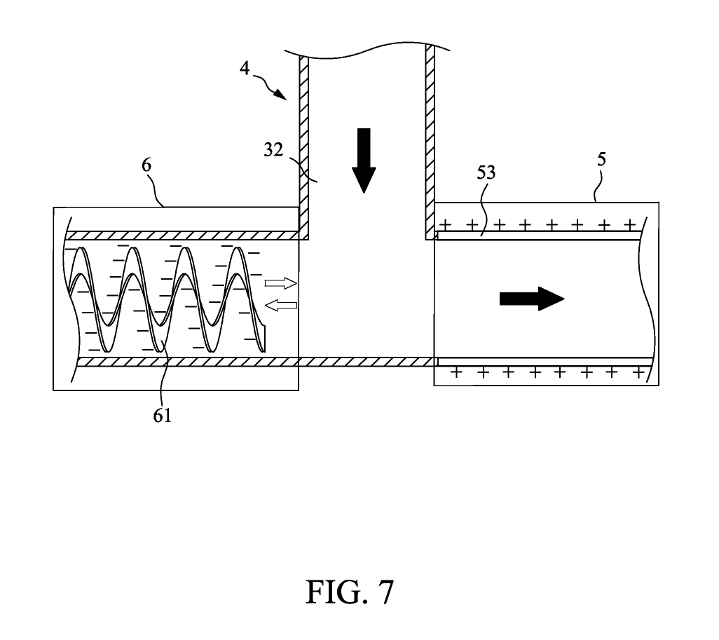

As shown in FIG. 7, and in accordance with another preferred exemplary embodiment of showing the charging pipeline 5 of the present invention, the charging pipeline 5 has a metal mesh 53 that is in connection with the housing 44. In addition, the screw 61 of the driving device 6 may also be designed to be made up of a metal material; the screw 61 and the metal mesh 53 make up a group of positive and negative electrodes that have opposite electrical properties. In other words, the metal mesh 53 of the charging pipeline 5 may perform the function of the positive electrode having positive electrons (cathode). Relative to this, the screw 61 of the driving device 6 may perform the function of the negative electrode that has negative electrons (anode).When the zinc electrode 32 passes through the discharging pipeline 4 and may be converted to oxidized zinc electrode 32 after reacting with air or oxygen, and when flowing past the charging pipeline 5, the oxidized zinc electrode 32 may be gradually reduced by both the metal mesh 53 and the screw 61. Finally after leaving the charging pipeline 5, the zinc electrode 32 may enter the discharging pipeline 4 and enabling the process of converting chemical energy into electrical energy to be started once again by a reaction with air or oxygen.

To illustrate this further, during the process of reducing the zinc electrode 32 in the charging pipeline 5, the oxygen that is produced diffuses out and may be released from the charging pipeline 5, via the holes and gaps of the metal mesh 53.

In addition to the above preferred exemplary embodiments of the present invention, as compared with the conventional zinc particle-type electrode 2, the colloidal electrolyte 22 of the zinc particle type electrode 2 does not have the special technical feature of mobility. As such, in comparison to the conventional zinc particle-type electrode 2 having a colloidal electrolyte 22 of zinc particles 21, the flow type zinc air fuel cell 3 of the present invention may be designed to have a slurry that has mobility, and together with the driving device 6 as well as the pressure device 7, the mobility and continuous flow of the zinc electrode 32 within the closed pipeline 31 may be achieved. At the same time of having mobility and continuous flow, the surface of the zinc electrode 32 may actually be in contact with the air or oxygen, and also significantly increasing the surface area of reaction; and finally, the discharging efficiency of the flow type zinc air fuel cell 3 of the present invention may be achieved.

Although the preferred exemplary embodiments of the present invention have been described with reference to the preferred exemplary embodiments thereof, it may be apparent to those ordinarily skilled in the art that a variety of modifications and changes may be made without departing from the scope of the present invention which is intended to be defined by the appended claims.

What is claimed is:

1. A flow type zinc air fuel cell, comprising a closed pipeline; the closed pipeline comprises a discharging pipeline and a charging pipeline that is in connection with the discharging pipeline, wherein the charging pipeline comprises a flow type zinc electrode that is in a slurry state, the outer periphery of the zinc electrode is encapsulated by a metal electricity collecting pipe, the outer periphery of the metal collecting electricity pipe is encapsulated by an insulating film, the outer periphery of the insulating film is encapsulated by an air electrode, the outer periphery of the air electrode is encapsulated by a housing comprising a plurality of through holes that enable air to enter the air electrode, at least one driving device exists in between the discharging pipeline and the charging pipeline; subsequent to an oxidation of the zinc electrode in the discharging pipeline, the zinc electrode is driven to the charging pipeline by the driving device, the zinc electrode is gradually reduced in the charging pipeline, the zinc electrode is pushed to the discharging pipeline by the driving device, to form a continuous cyclical oxidation and reduction reaction that generates electricity.

2. The flow type zinc air fuel cell according to claim 1, wherein the zinc electrode comprises a compound or a mixture containing zinc metals, the zinc metals comprise one of zinc particles or zinc powders, or a mixture thereof.

3. The flow type zinc air fuel cell according to claim 1, wherein the material of the metal electricity collecting pipe comprises one of a copper or a nickel.

4. The flow type zinc air fuel cell according to claim 1, wherein the driving device comprises a driving source and a screw that moves back and forth and that is being driven by the driving source in a single direction.

5. The flow type zinc air fuel cell according to claim 4, wherein the charging pipeline comprises a metal mesh that is in connection with the housing, the screw and the metal mesh comprise a group of positive and negative electrodes that may carry out the reduction reaction of the zinc electrode within the charging pipeline subsequent to the oxidation.

6. The flow type zinc air fuel cell according to claim 1, wherein the charging pipeline comprises a metal pipeline that is in connection with the housing, and the metal pipeline further comprises a metal rod piece; the metal pipeline and the metal rod piece comprise a group that may carry out the reduction reaction of the zinc electrode within the charging pipeline subsequent to the oxidation.

7. The flow type zinc air fuel cell according to claim 6, wherein a surface of the metal rod piece comprises a plurality of air holes, the oxygen produced subsequent to reduction reaction of the oxidized zinc electrode enters the metal rod piece, and is guided released through the metal rod piece.

8. The flow type zinc air fuel cell according to claim 1, wherein the discharging pipeline further comprises a pressure device that may increase the speed of the displacement flow of the zinc electrode.
